(19) United States
(12) Patent Application Publication
(10) Pub. No.: US 2007/0002031 A1
(43) Pub. Date: Jan. 4, 2007

(54) Display device

(75) Inventor: Yu Tsung Tsai, Puzih City (TW)

Correspondence Address: TROXELL LAW OFFICE PLLC, SUITE 1404, 5205 LEESBURG PIKE, FALLS CHURCH, VA, 22041, US

(73) Assignee: Formosa Plasma Display Corp.

(21) Appl. No.: 11/168,485

(22) Filed: Jun. 29, 2005

(51) Int. Cl. G09G 5/00

(52) U.S. Cl. 345/204

(57) ABSTRACT

A display device comprising a driving voltage generating apparatus, a driver circuit, and a display panel is disclosed. The driving voltage generating apparatus comprises a transformer element, a plurality of current-limiting elements, and a plurality of voltage-stabilizing elements. The transformer element has a plurality of secondary coils, which, coupled with current-limiting element capable of rectification and voltage-stabilizing element capable of filtering out noise, allows the driving voltage generating apparatus to output simultaneously positive voltage and negative voltage needed by the driver circuit of the display.

### BACKGROUND OF INVENTION

1. Field of the Invention

The present invention relates to a display device, more particularly a display device having high-performance driving voltage generating apparatus.

2. Description of the Prior Art

Among the wide varieties of electronic products, display devices of various kinds (e.g. cold cathode tube display, liquid crystal display panel and plasma display panel) are gaining popularity. With the advancement of manufacturing technology, display devices are able to meet the demands for size, picture quality, weight and price.

But irrespective of the type of display, they all use panel to display images and pictures. Such panel typically contains many crisscross scan lines, which when driven under proper driving voltage, can display images accurately on the display panel.

FIG. 1 is a schematic view of a display panel, assuming the display panel 108 will display images accurately when it is driven by a voltage having waveform 106. Voltage waveform 106 is a square waveform having positive and negative voltages needed by the positive voltage input Vₛ₁ and negative voltage input −Vₛ₂ of driver circuit 104. Thus an element that can generate such positive voltage and negative voltage is required for driver circuit 104 to produce voltage waveform 106.

In typical circuitry, transformer shown as 102 in FIG. 1 is commonly used to provide the required voltage. But a simple transformer is designed only to produce one voltage. For example, after a voltage Vᵢₙ is input into transformer 102, an output of transformer must be connected to ground potential GND, while its other output can only output the positive voltage needed by driver circuit 104.

To produce the negative voltage needed by driver circuit 104, an inverter circuit 110 must be added to the voltage supply scheme. The inverter circuit 110 can reverse the polarity of voltage. So it is bridged over the output of transformer 102 to receive its positive voltage output and convert the positive voltage into negative voltage before inputting it into the negative voltage input −Vₛ₂ of driver circuit 104. As such, the positive voltage input Vₛ₁ and negative voltage input −Vₛ₂ of driver circuit 104 will obtain respectively a positive voltage and a negative voltage.

It is well known in the art of circuitry design that an inverter circuit 110 contains at least a plurality of transistors, so certain loss occurs in each component when the positive voltage output from transformer 102 is processed by inverter circuit 110. As a result, the quality of negative voltage produced is not as expected and leads to loss of electrical energy efficiency. Moreover, inverter circuit 110 requires a separate control circuit (not shown in FIG. 1) to control its operation. When small size and light weight are requisites of a display device, inverter circuit 110 apparently will take considerable space of the circuitry, which makes further shrinkage of display size difficult and adds to the production cost.

As described above, a driving voltage generating apparatus that is smaller, costs less and offers better operating efficiency is needed for display device.

### SUMMARY OF INVENTION

The primary object of the present invention is to provide a display device.

Another object of the present invention is to provide a display device having a driving voltage generating apparatus that can supply positive and negative output voltages simultaneously.

A further object of the present invention is to provide a display device having a highly efficient driving voltage generating apparatus.

Yet another object of the present invention is to provide a low-cost and small-size display device configuration.

To achieve the aforesaid objects, an example of the display device according to the present invention uses a display panel, a driver circuit and a driving voltage generating apparatus, wherein the driver circuit is for driving the display panel and comprises at least one positive voltage input and at least one negative voltage input, while the driving voltage generating apparatus is for supplying positive voltage and negative voltage needed by the positive voltage input and negative voltage input.

The driving voltage generating apparatus in one example of the present invention comprises a transformer element, at least one first current-limiting element, at least one second current-limiting element, at least one first voltage-stabilizing element, and at least one second voltage-stabilizing element. The transformer element contains at least a primary coil, at least one first secondary coil, and at least one second secondary coil, and the homopolar end of the first secondary coil and the heteropolar end of the second secondary coil are connected to a ground potential. The forward terminal and the backward terminal of the first current-limiting element are respectively connected to the heteropolar end of first secondary coil and the positive voltage input. The forward terminal and the backward terminal of the second current-limiting element are respectively connected to negative voltage input and homopolar end of second secondary coil. The two ends of the first voltage-stabilizing element are respectively connected to the backward terminal of first current-limiting element and the homopolar end of first secondary coil. The two ends of second voltage-stabilizing element are respectively connected to the forward terminal of second current-limiting element and the heteropolar end of second secondary coil.

In another example of the present invention, the driving voltage generating apparatus comprises a transformer element, at least one first current-limiting element, at least one second current-limiting element, at least one third current-limiting element, at least one fourth current-limiting element, at least one first voltage-stabilizing element, and at least one second voltage-stabilizing element. The transformer element comprises at least a primary coil, at least one first secondary coil, at least one second secondary coil, at least one third secondary coil, and at least one fourth secondary coil. The homopolar end of first secondary coil, the heteropolar end of second secondary coil, the homopolar end of third secondary coil, and the heteropolar end of fourth secondary coil are all connected to a ground potential. In addition, the forward terminal and the backward terminal of first current-limiting element are respectively connected to the heteropolar end of first secondary coil and positive voltage input. The forward terminal and the backward terminal of second current-limiting element are respectively connected to the homopolar end of second secondary coil and the backward terminal of first current-limiting current. The forward terminal and the backward terminal of third current-limiting element are respectively connected to negative voltage input and heteropolar end of third secondary coil. The forward terminal and the backward terminal of fourth current-limiting element are respectively connected to forward terminal of third current-limiting element and homopolar end of fourth secondary coil. The two ends of first voltage-stabilizing element are respectively connected to the backward terminal of first current-limiting element and homopolar end of first secondary coil. The two ends of second voltage-stabilizing element are respectively connected to the forward terminal of fourth current-limiting element and heteropolar end of fourth secondary coil.

In this example, the first current-limiting element, the second current-limiting element, the third current-limiting element, and the fourth current-limiting element are diodes, where the forward terminals and backward terminals of the current-limiting elements are respectively anode and cathode of the diode. The first voltage-stabilizing element and the second voltage-stabilizing element are capacitors.

### BRIEF DESCRIPTION OF THE DRAWINGS

The details of the present invention will be more readily understood from a detailed description of the preferred embodiments taken in conjunction with the following figures.

FIG. 1 is a schematic view of a conventional display device configuration.

FIG. 2 is a schematic view of an example of display device configuration according to the invention.

FIG. 3 is a schematic view of another example of display device configuration according to the invention.

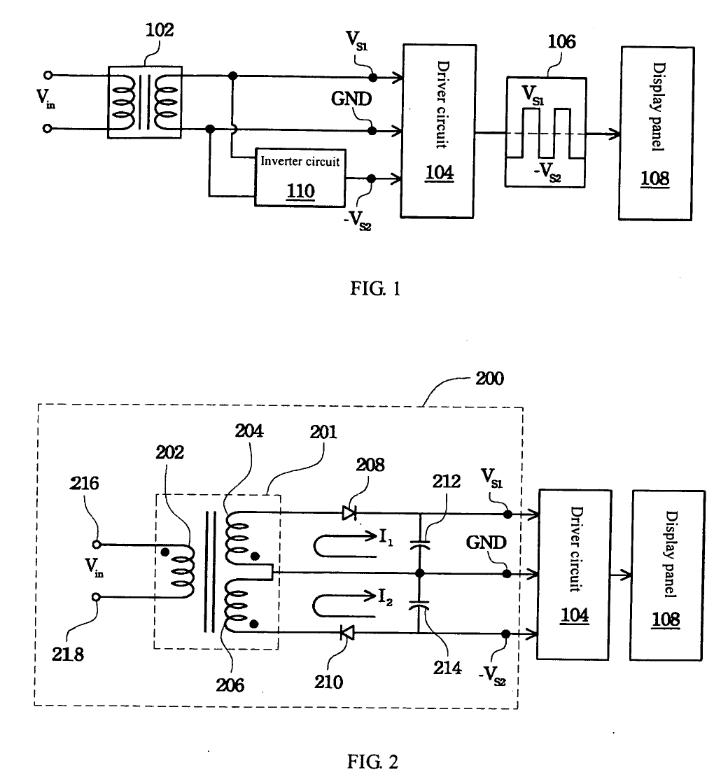

### DETAILED DESCRIPTION

In the driving voltage generating apparatus of conventional display panels, the transformer usually supplies either a positive voltage or negative voltage to maintain voltage stability. In such design, the driver circuit relies on an external inverter circuit to produce the negative voltage or positive voltage it needs, which not only incurs energy loss, but also takes more circuitry space. The basic concept of the present invention is to allow the transformer element to supply at the same time positive voltage and negative voltage with no need for inverter circuit.

The objects, features, and advantages of the present invention are further described below with accompanying drawings.

FIG. 2 is a schematic view of a display device configuration according to the invention. The display device comprises a driving voltage generating apparatus 200, a driver circuit 104, and a display panel 108. The driving voltage generating apparatus 200 comprises a transformer element 201, a first current-limiting element 208, a second current-limiting element 210, a first voltage-stabilizing element 212 and a second voltage-stabilizing element 214. The current-limiting element is, for example, a diode, and the voltage-stabilizing element is, for example, a capacitor. The transformer element 201 comprises three coils: a primary coil 202, a first secondary coil 204 and a second secondary coil 206. The primary coil 202 has two ends 216 and 218 to receive input voltage Vᵢₙ. Based on the principles of transformer, the two ends of those three coils are respectively a homopolar end and a heteropolar end. The homopolar ends are indicated by a round dot. For example, the end 216 of primary coil 202 is a homopolar end, and the end 218 of coil 202 is a heteropolar end.

Next the connections of those elements are described. The input ends 216 and 218 of primary coil 202 are connected to input voltage Vᵢₙ, while the homopolar end of first secondary coil 204 and the heteropolar end of second secondary coil 206 are connected to the ground potential GND of the entire display system. The forward terminal of first current-limiting element 208 is connected to the heteropolar end of first secondary coil 204, while the backward terminal of first current-limiting element 208 is connected to the positive voltage input Vₛ₁ of driver circuit 104, so as to provide positive voltage to the positive voltage input Vₛ₁ of driver circuit 104. The forward terminal and the backward terminal of current-limiting elements 208 and 210 represent respectively the anode and cathode of diode. The backward terminal of second current-limiting element 210 is connected to the homopolar end of second secondary coil 206. The forward terminal of second current-limiting element 210 is connected to the negative voltage input −Vₛ₂ of driver circuit 104, so as to provide negative voltage to the negative voltage input −Vₛ₂ of driver circuit 104. The two ends of first voltage-stabilizing element 212 are respectively connected to positive voltage input Vₛ₁ and ground potential GND, and the two ends of second voltage-stabilizing element 214 are respectively connected to negative voltage input −Vₛ₂ and ground potential GND.

In light that input voltage Vᵢₙ is an AC voltage generated by the action of alternating power, the current flowing on primary coil 202 would cyclically switch direction. First when a cyclic current flows through primary coil 202 from end 218 to end 216, currents I₁ and I₂ would be induced on first secondary coil 204 and second secondary coil 206 respectively. Because currents I₁ and I₂ are forward current to first current-limiting element 208 and second current-limiting element 210, the positive voltage generated from both ends of first secondary coil 204 are relayed to the backward terminal of first current-limiting element 208 to produce positive voltage needed by the positive voltage input Vₛ₁, while the negative voltage generated from both ends of second secondary coil 206 may be relayed to the forward terminal of second current-limiting element 210 to produce negative voltage needed by negative voltage input −Vₛ₂. The first voltage-stabilizing element 212 and second voltage-stabilizing element 214 are used respectively to isolate noises between positive voltage, ground potential GND and negative voltage.

Conversely when another cyclic current flows through primary coil 202 from end 216 to end 218, currents in reverse direction to I₁ and I₂ would be induced on first secondary coil 204 and second secondary coil 206 respectively. At this time because of the action of first current-limiting element 208 and second current-limiting element 210, no voltage would be generated on positive voltage input Vₛ₁ or negative voltage input −Vₛ₂. That is, the driving voltage generating apparatus 200 shown in FIG. 2 has a half-cycle configuration, which saves more circuit space and costs.

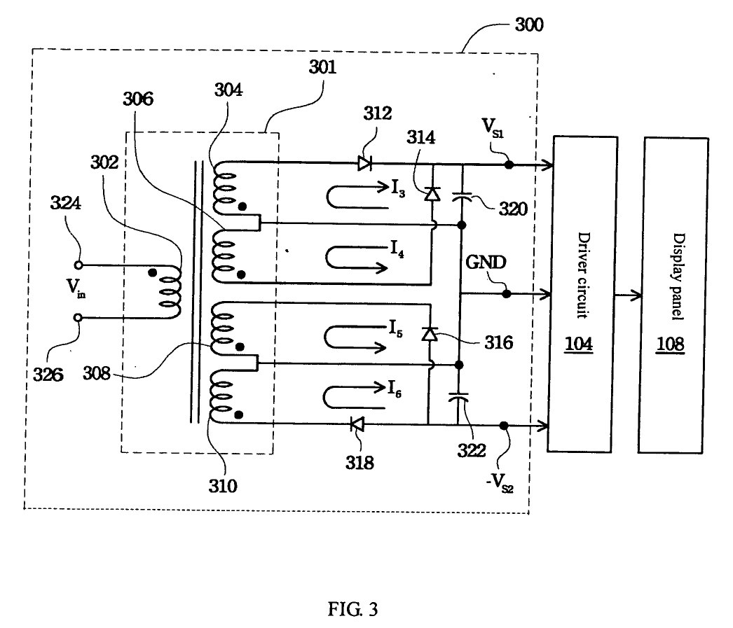

FIG. 3 is the schematic view of another display device configuration according to the invention. The display device comprises a driving voltage generating apparatus 300, a driver circuit 104, and a display panel 108. The driving voltage generating apparatus 300 comprises a transformer element 301, a first current-limiting element 312, a second current-limiting element 314, a third current-limiting element 316, a fourth current-limiting element 318, a first voltage-stabilizing element 320 and a second voltage-stabilizing element 322. The transformer element 301 comprises five coils—a primary coil 302, a first secondary coil 304, a second secondary coil 306, a third secondary coil 308, and a fourth secondary coil 310. The primary coil 302 has two ends 324 and 326 to receive input voltage Vᵢₙ. Based on the basic principles of transformer, the two ends of those five coils are respectively a homopolar end and a heteropolar end. The homopolar ends are indicated by a round dot. For example, the end 324 of primary coil 302 is a homopolar end, and the end 326 of primary coil 302 is a heteropolar end.

Next the connections of those elements are described. The input ends 324 and 326 of primary coil 302 are connected to input voltage Vᵢₙ, while the homopolar ends of first secondary coil 304 and third secondary coil 308 and the heteropolar ends of second secondary coil 306 and fourth secondary coil 310 are connected to the ground potential GND of the entire display system. The forward terminal of first current-limiting element 312 is connected to the heteropolar end of first secondary coil 304, while the backward terminal of first current-limiting element 312 is connected to the positive voltage input Vₛ₁ of driver circuit 104, so as to provide positive voltage to the positive voltage input Vₛ₁ of driver circuit 104. The forward terminal of second current-limiting element 314 is connected to the homopolar end of second secondary coil 306, while the backward terminal of second current-limiting element 314 is connected to the positive voltage input Vₛ₁ of driver circuit 104, so as to supply positive voltage to the positive voltage input Vₛ₁ of driver circuit 104. The forward terminal of third current-limiting element 316 is connected to the negative voltage input −Vₛ₂ of driver circuit 104, while the backward terminal of third current-limiting element 316 is connected to the heteropolar end of third secondary coil 308, so as to supply negative voltage to the negative voltage input −Vₛ₂ of driver circuit 104.

The backward terminal of fourth current-limiting element 318 is connected to the homopolar end of fourth secondary coil 310, while the forward terminal of fourth current-limiting element 318 is connected to the negative voltage input −Vₛ₂ of driver circuit 104, so as to supply negative voltage to the negative voltage input −Vₛ₂ of driver circuit 104. The two ends of first voltage-stabilizing element 320 are respectively connected to positive voltage input Vₛ₁ and ground potential GND, and the two ends of second voltage-stabilizing element 322 are respectively connected to negative voltage input −Vₛ₂ and ground potential GND.

In light that input voltage Vᵢₙ is an AC voltage generated by the action of alternating power, the current flowing on primary coil 302 would cyclically switch direction. First when a cyclic current flows through primary coil 302 from end 326 to end 324, currents I₃ and I₆ would be induced on first secondary coil 304 and fourth secondary coil 310 respectively. Because currents I₃ and I₆ are forward current to first current-limiting element 312 and fourth current-limiting element 318, the positive voltage generated from both ends of first secondary coil 304 are relayed to the backward terminal of first current-limiting element 312 to produce positive voltage needed by the positive voltage input Vₛ₁, while the negative voltage generated from both ends of fourth secondary coil 310 may be relayed to the forward terminal of fourth current-limiting element 318 to produce negative voltage needed by negative voltage input −Vₛ₂. At this time because of the action of second current-limiting element 314 and third current-limiting element 316, no current would pass through second secondary coil 306 or third secondary coil 308. The first voltage-stabilizing element 320 and second voltage-stabilizing element 322 are used respectively to isolate noises between positive voltage, ground potential GND and negative voltage.

Conversely when another cyclic current flows through primary coil 302 from end 324 to end 326, currents in reverse direction to I₄ and I₅ would be induced on second secondary coil 306 and third secondary coil 308 respectively. Because currents I₄ and I₅ are forward current to second current-limiting element 314 and third current-limiting element 316, the positive voltage generated from both ends of second secondary coil 306 are relayed to the backward terminal of second current-limiting element 314 to produce positive voltage needed by the positive voltage input Vₛ₁, while the negative voltage generated from both ends of third secondary coil 308 may be relayed to the forward terminal of third current-limiting element 316 to produce negative voltage needed by negative voltage input −Vₛ₂. At this time because of the actions of first current-limiting element 312 and fourth current-limiting element 318, no current would pass through first secondary coil 304 or fourth secondary coil 310. That is, the driving voltage generating apparatus 300 shown in FIG. 3 has a full-cycle configuration, which could enhance the use efficiency of electric energy.

From the examples provided above, either the configuration of half-cycle action or full-cycle action scraps the needs for an external inverter circuit to provide the positive voltage and negative voltage needed by the driver circuit of display device. And, the magnitude of voltage output may be decided by the turns of the primary coil and secondary coil and the duty cycle thereof, which gives the designer more flexibility. The aforesaid examples use diodes and capacitors to perform the functions of current-limiting elements and voltage-stabilizing elements, in which, the anode and cathode of the diode are respectively the forward terminal and backward terminal of current-limiting element. Other devices that can achieve the same objectives may also be used. By the same principle, if the driver circuit in the display configuration requires several sets of positive voltage and negative voltage, it can be achieved by adding more sets of secondary coils in the transformer element. The presence of more sets of secondary coils can provide more sets of positive voltage and negative voltage. Thus the number of primary coil and secondary coil is not limited by the examples described above.

Preferred embodiments of the present invention have been disclosed in the examples. However the descriptions made in the examples should not be construed as a limitation on the actual applicable scope of the present invention, and as such, all modifications and alterations without departing from the spirits of the invention shall remain within the protected scope and claims of the invention.

What is claimed is:

1. A display device, comprising:
a display panel;
a driver circuit for driving the display panel comprising at least one positive voltage input and at least one negative voltage input; and
a driving voltage generating apparatus for supplying respectively positive voltage and negative voltage needed by said positive voltage input and said negative voltage input, said driving voltage generating apparatus further comprising:
a transformer element comprising at least a primary coil, at least one first secondary coil and at least one second secondary coil, homopolar end of the first secondary coil and heteropolar end of the second secondary coil being connected to a ground potential;
at least one first current-limiting element, forward terminal and backward terminal of the first current-limiting element being connected respectively to heteropolar end of the first secondary coil and the positive voltage input;
at least one second current-limiting element, forward terminal and backward terminal of the second current-limiting element being connected respectively to the negative voltage input and homopolar end of the second secondary coil;
at least one first voltage-stabilizing element, two ends of the first voltage-stabilizing element being connected respectively to the backward terminal of the first current-limiting element and the homopolar end of the first secondary coil; and
at least one second voltage-stabilizing element, two ends of the second voltage-stabilizing element being connected respectively to the forward terminal of the second current-limiting element and the heteropolar end of the second secondary coil.

2. The display device according to claim 1, wherein the first current-limiting element and the second current-limiting element are diodes, and the forward terminals and backward terminals of the current-limiting elements are respectively anodes and cathodes of diodes.

3. The display device according to claim 1, wherein the first voltage-stabilizing element and the second voltage-stabilizing element are capacitors.

4. A display device, comprising:
a display panel;
a driver circuit for driving the display panel comprising at least one positive voltage input and at least one negative voltage input; and
a driving voltage generating apparatus for supplying respectively positive voltage and negative voltage needed by said positive voltage input and said negative voltage input, said driving voltage generating apparatus further comprising:
a transformer element comprising at least a primary coil, at least one first secondary coil, at least one second secondary coil, at least one third secondary coil and at least one fourth secondary coil, and homopolar end of the first secondary coil, heteropolar end of the second secondary coil, homopolar end of the third secondary coil, and heteropolar end of the fourth secondary coil being connected to a ground potential;
at least one first current-limiting element, forward terminal and backward terminal of the first current-limiting element being connected respectively to heteropolar end of the first secondary coil and the positive voltage input;
at least one second current-limiting element, forward terminal and backward terminal of the second current-limiting element being connected respectively to homopolar end of the second secondary coil and backward terminal of the first current-limiting element;
at least one third current-limiting element, forward terminal and backward terminal of the third current-limiting element being connected respectively to the negative voltage input and heteropolar end of the third secondary coil;
at least one fourth current-limiting element, forward terminal and backward terminal of the fourth current-limiting element being connected respectively to forward terminal of the third current-limiting element and homopolar end of the fourth secondary coil;
at least one first voltage-stabilizing element, two ends of the first voltage-stabilizing element being connected respectively to the backward terminal of the first current-limiting element and the homopolar end of the first secondary coil; and
at least one second voltage-stabilizing element, two ends of the second voltage-stabilizing element being connected respectively to the forward terminal of the fourth current-limiting element and the heteropolar end of the fourth secondary coil.

5. The display device according to claim 4, wherein the first current-limiting element, the second current-limiting element, the third current-limiting element and the fourth current-limiting current are diodes, and the forward terminals and backward terminals of the current-limiting elements are respectively anodes and cathodes of diodes.

6. The display device according to claim 4, wherein the first voltage-stabilizing element and the second voltage-stabilizing element are capacitors.
